(19) United States
(12) Patent Application Publication
(10) Pub. No.: US 2021/0371594 A1
(43) Pub. Date: Dec. 2, 2021

(54) HEAT-CURABLE MALEIMIDE RESIN COMPOSITION AND ADHESIVE AGENT, SUBSTRATE MATERIAL, PRIMER, COATING MATERIAL AND SEMICONDUCTOR DEVICE USING SAME

(71) Applicant: Shin-Etsu Chemical Co., Ltd., Tokyo (JP)

(72) Inventors: Yuki KUDO, Annaka-shi (JP); Yoshihiro TSUTSUMI, Annaka-shi (JP); Shinsuke YAMAGUCHI, Annaka-shi (JP)

(73) Assignee: Shin-Etsu Chemical Co., Ltd., Tokyo (JP)

(21) Appl. No.: 17/313,101

(22) Filed: May 6, 2021

(30) Foreign Application Priority Data
May 19, 2020 (JP) 2020-087466

(51) Int. Cl. C08G 73/12; C08L 79/08; C09J 179/08; C09D 179/08

(52) U.S. Cl. CPC C08G 73/128; C09D 179/085; C09J 179/085; C08L 79/085

(57) ABSTRACT

Provided are a heat-curable maleimide resin composition capable of yielding a cured product with a high glass-transition temperature, excellent dielectric properties and a superior adhesiveness to a metal foil, and being evenly cured with no curing unevenness at the time of curing due to its favorable compatibility with other resins; and an adhesive agent, substrate material, primer, coating material and semiconductor device containing such composition. This heat-curable maleimide resin composition contains (A) a maleimide compound and (B) a reaction promoter.

### BACKGROUND OF THE INVENTION

### Field of the Invention

The present invention relates to a heat-curable maleimide resin composition; and an adhesive agent, substrate material, primer, coating material and semiconductor device using the same.

### Background Art

In recent years, as electronic devices are becoming smaller and reaching a higher level of performance, it is required that wirings in a multilayered printed-wiring board be established in a finer and highly dense manner. Further, since a material intended for use in high frequency ranges is required in the next generation, and a reduction in transmission loss is essential as a countermeasure for noises, an insulating material superior in dielectric properties needs to be developed.

As an insulating material for use in a multilayered printed-wiring board, there is known an epoxy resin composition(s) containing, for example, an epoxy resin, a particular phenolic curing agent, a phenoxy resin, rubber particles and a polyvinyl acetal resin, as are disclosed in JP-A-2007-254709 and JP-A-2007-254710. However, it has become clear that these materials are not satisfactory in terms of high-frequency application which is often referred to by the keyword “5G.” In this regard, JP-A-2011-132507 reports that an epoxy resin composition comprising an epoxy resin, an active ester compound and a triazine-containing cresol novolac resin is effective in lowering a dielectric tangent. However, if used for high-frequency application, lower dielectric properties are required even with this type of material.

Meanwhile, WO2016/114287 reports that a resin film made of a resin composition comprising a long-chain alkyl group-containing bismaleimide resin and a curing agent, as a non-epoxy material, is excellent in terms of exhibiting low dielectric properties. Since this composition is technically a combination of a long-chain alkyl group-containing bismaleimide resin and a hard low-molecular aromatic maleimide, a poor compatibility will be exhibited, property variation and curing unevenness will occur easily, and it is thus extremely difficult to reach a high glass-transition temperature (Tg) of 100° C. or higher as required for substrate use.

Further, researches in recent years have shown that there exists a trade-off correlation where due to the resin design of the above long-chain alkyl group-containing bismaleimide resin, poor dielectric properties will be exhibited if a higher Tg is sought, whereas a lower Tg will be exhibited if dielectric properties are to be improved. Furthermore, it has also been shown that if seeking a higher Tg, even identical long-chain alkyl group-containing bismaleimide resins themselves will undergo agglomeration and separation, and a compatibility between the resins will deteriorate as well.

In addition, disclosed in JP-A-2017-119361 and JP-A-2019-104843 are, for example, a resin composition(s) containing a polyimide(s) whose raw materials include an aromatic tetracarboxylic acid anhydride; and an alicyclic diamine or a dimer diamine derived from a dimer acid as a dimer of an unsaturated fatty acid such as oleic acid. However, the polyimide described in any of these documents is unfit for use if hardened alone, and has a poor compatibility with other resins. Moreover, since the polyimide undergoes cyclodehydration at the time of hardening, swelling will easily occur under a use condition where, for example, a resin composition containing the polyimide is to be attached to a metallic foil, which results in an unfavorable situation.

In view of such background, in recent years, a polyphenylene ether resin(s) (PPE) that is curable by heat by modifying the functional groups at the molecular chain ends, is used as a main resin for 5G substrate uses, as are disclosed in JP-A-2017-128718 and JP-A-2018-95815. A modified PPE has an excellent reliability as a cured product thereof has a high Tg of not lower than 200° C.

### SUMMARY OF THE INVENTION

For 5G uses, in terms of skin effect, a metal foil with a low surface roughness is preferred as an increase in transmission loss will be observed if using a metal foil with a high surface roughness. However, since an anchor effect cannot be achieved if employing a metal foil with a low surface roughness, a resin having a higher adhesiveness to a metal foil is desired; in this regard, the modified PPEs described in JP-A-2017-128718 and JP-A-2018-95815 have a problem in adhesiveness to metal foils.

Therefore, it is an object of the present invention to provide a heat-curable maleimide resin composition capable of yielding a cured product with a high glass-transition temperature (Tg), excellent dielectric properties and a superior adhesiveness to a metal foil, and being evenly cured with no curing unevenness at the time of curing due to its favorable compatibility with other resins; and an adhesive agent, substrate material, primer, coating material and semiconductor device using such composition.

The inventors of the present invention diligently conducted a series of studies to solve the above problem(s) and completed the invention as follows. That is, the inventors found that the following heat-curable maleimide resin composition is able to achieve the aforementioned object.

[1]

A heat-curable maleimide resin composition comprising:
(A) a maleimide compound represented by the following formula (1) and having a number average molecular weight of 3,000 to 50,000,

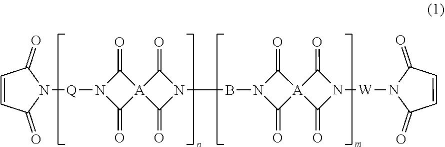

wherein A independently represents a tetravalent organic group having a cyclic structure, B independently represents a divalent hydrocarbon group having 6 to 200 carbon atoms, Q independently represents a cyclohexane backbone-containing divalent alicyclic hydrocarbon group having 6 to 60 carbon atoms, W represents B or Q, n represents 1 to 100, m represents 0 to 100, repeating units identified by n and m are present in any order, a bonding pattern of the repeating units n and m may be alternate, block or random, and

wherein Q is independently represented by the following formula (2):

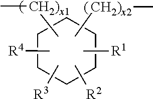

wherein each of R¹, R², R³ and R⁴ independently represents a hydrogen atom or an alkyl group having 1 to 5 carbon atoms, each of x1 and x2 represents a number of 0 to 4; and
(B) a reaction promoter.
   [2]

The heat-curable maleimide resin composition according to [1], further comprising:
(C) a heat-curable resin having, as a reactive group(s) reactive with maleimide groups, at least one kind of group selected from an epoxy group, a maleimide group, a hydroxyl group, an acid anhydride group, an alkenyl group, a (meth)acrylic group and a thiol group.
   [3]

The heat-curable maleimide resin composition according to [1] or [2], wherein the bonding pattern of the repeating units identified by n and m is block in the alicyclic backbone-containing maleimide compound represented by the formula (1).

[4]

The heat-curable maleimide resin composition according to any one of [1] to [3], wherein A in the formula (1) represents any one of the tetravalent organic groups expressed by the following structural formulae:

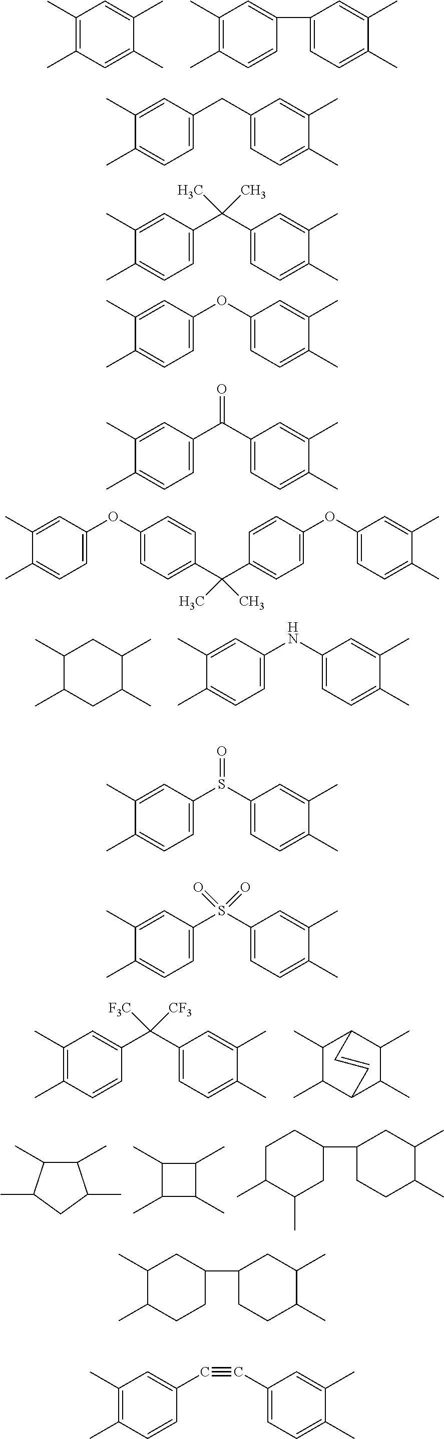

wherein bonds in the above structural formulae that are yet unbonded to substituent groups are to be bonded to carbonyl carbons forming cyclic imide structures in the formula (1).

[5]

The heat-curable maleimide resin composition according to any one of [1] to [4], wherein B in the formula (1) comprises at least one kind of the divalent hydrocarbon groups represented by the following structural formulae (3-1), (3-2), (4) and (5):

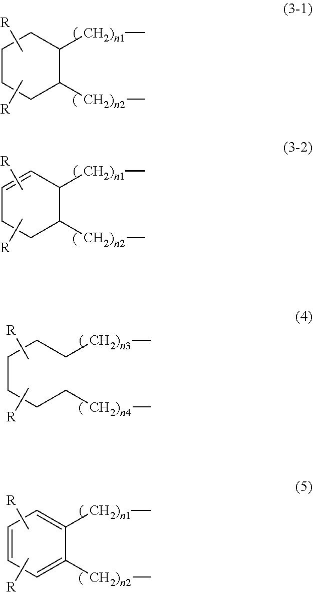

wherein n¹ and n² each represent a number of 5 to 30, and may be identical to or different from each other; n³ and n⁴ each represent a number of 4 to 24, and may be identical to or different from each other; R independently represents a hydrogen atom, or a linear or branched alkyl or alkenyl group having 4 to 40 carbon atoms.

[6]

A sheet-shaped or film-shaped composition comprising the heat-curable maleimide resin composition according to any one of [1] to [5].

[7]

An adhesive agent composition comprising the heat-curable maleimide resin composition according to any one of [1] to [5].

[8]

A primer composition comprising the heat-curable maleimide resin composition according to any one of [1] to [5].

[9]

A composition for a substrate, comprising the heat-curable maleimide resin composition according to any one of [1] to [5]. [10]

A coating material composition comprising the heat-curable maleimide resin composition according to any one of [1] to [5].

[11]

A semiconductor device having a cured product of the heat-curable maleimide resin composition according to any one of [1] to [5].

The heat-curable maleimide resin composition of the present invention is capable of yielding a cured product with a high glass-transition temperature, excellent dielectric properties and a superior adhesiveness to a metal foil. Further, since the maleimide compound contained in the heat-curable maleimide resin composition of the present invention has a superior compatibility with other resins having different structures, the composition of the present invention can be easily used in combination with other resins, and can readily contribute to extracting better performances by a mutual performance compensation. In addition, the heat-curable maleimide resin composition of the present invention is capable of being evenly cured with no curing unevenness at the time of curing; particularly, a low level of variation in curability and property of the composition is observed when the composition is molded into the shape of a sheet, film or substrate.

Thus, the heat-curable maleimide resin composition of the present invention is suitable for use in an adhesive agent, a substrate material, a primer, a coating material and a semiconductor device.

### DETAILED DESCRIPTION OF THE INVENTION

The present invention is described in greater detail hereunder.

### (A) a Maleimide Compound Represented by the Following Formula (1) and Having a Number Average Molecular Weight of 3,000 to 50,000

A component (A) is an alicyclic backbone-containing maleimide compound represented by the following formula (1) and having a number average molecular weight of 3,000 to 50,000. It is preferred that this maleimide compound have at least 2, preferably 2 to 5 maleimide groups in one molecule.

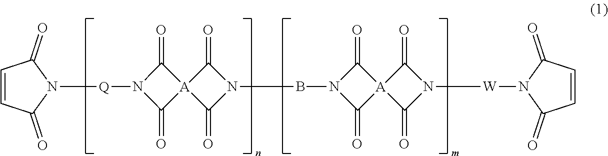

In the above formula (1), A independently represents a tetravalent organic group having a cyclic structure.

B independently represents a divalent hydrocarbon group having 6 to 200 carbon atoms.

Q independently represents a cyclohexane backbone-containing divalent alicyclic hydrocarbon group that has 6 to 60 carbon atoms and is represented by the following formula (2):

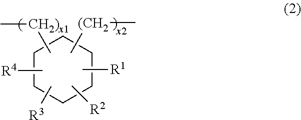

wherein each of R¹, R², R³ and R⁴ independently represents a hydrogen atom or an alkyl group having 1 to 5 carbon atoms; each of x1 and x2 represents a number of 0 to 4.

W represents B or Q.

n represents 1 to 100, m represents 0 to 100.

Further, there are no restrictions on an order in which units identified by n and m are repeated; a bonding pattern of these units may be alternate, block or random.

The number average molecular weight of the maleimide compound as the component (A) is 3,000 to 50,000, preferably 5,000 to 40,000. It is preferred that the number average molecular weight of this maleimide compound fall into these ranges, because a favorable solvent solubility and a favorable compatibility to other resins will be achieved. Further, when the number average molecular weight is within these ranges, there will be obtained a favorable cured product exhibiting a low level of post-curing property variation and curing unevenness.

Here, the term “number average molecular weight” referred to in the present invention means a number average molecular weight measured by gel permeation chromatography (GPC) under the following conditions, using polystyrene as a reference substance.

### Measurement Condition

Developing solvent: Tetrahydrofuran
Flow rate: 0.35 mL/min

### Detector: RI

Column: TSK-GEL H type (by TOSOH CORPORATION)
Column temperature: 40° C.
Sample injection volume: 5 μL

In the formula (1), A independently represents a tetravalent organic group having a cyclic structure, and it is preferred that A represent any one of the tetravalent organic groups represented by the following structural formulae:

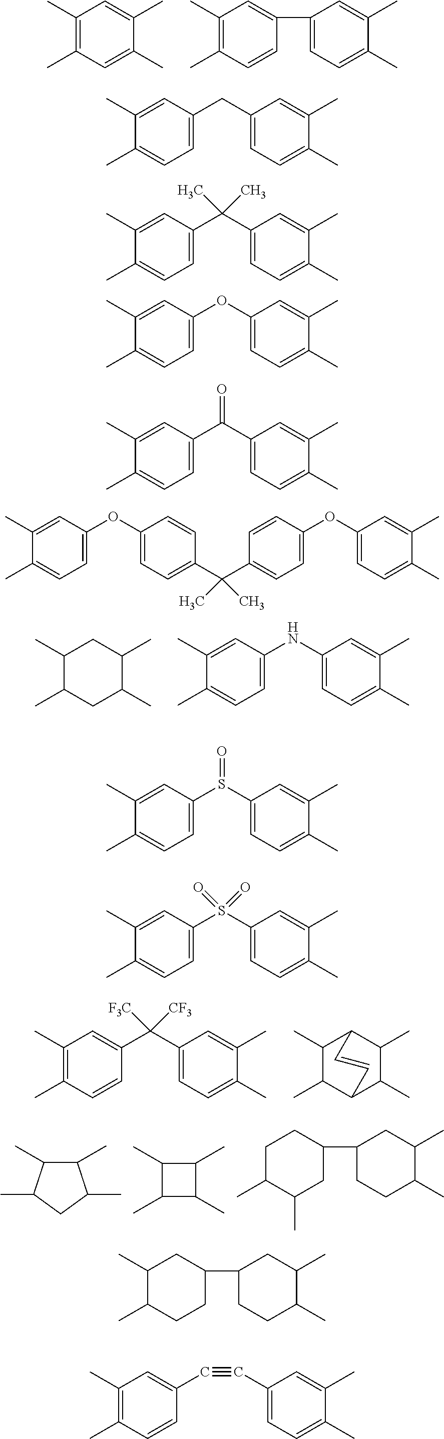

wherein bonds in the above structural formulae that are yet unbonded to substituent groups are to be bonded to carbonyl carbons forming cyclic imide structures in the general formula (1).

Further, in the formula (1), B independently represents a divalent hydrocarbon group having 6 to 200, preferably 8 to 100, more preferably 10 to 50 carbon atoms. Here, it is preferred that B be a branched divalent hydrocarbon group with at least one hydrogen atom therein being substituted by an alkyl group or alkenyl group having 6 to 200, preferably 8 to 100, more preferably 10 to 50 carbon atoms. Such branched divalent hydrocarbon group may be either a saturated aliphatic hydrocarbon group or an unsaturated hydrocarbon group, and an alicyclic structure or aromatic ring structure may be present midway through the molecular chain. Specific examples of the branched divalent hydrocarbon group include a hydrocarbon group derived from a dual-end diamine called dimer diamine. Particularly, dimer diamine refers to a compound derived from a dimer of an unsaturated aliphatic acid such as oleic acid.

Specific examples of the branched divalent hydrocarbon group include at least one of the divalent hydrocarbon groups represented by the following structural formulae (3-1), (3-2), (4) and (5).

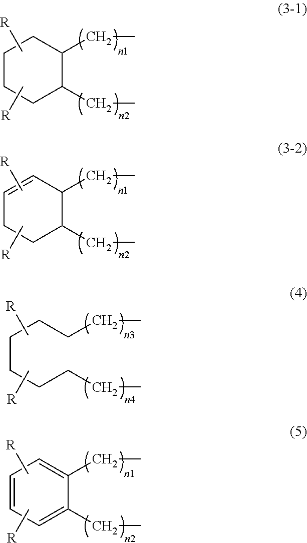

Here, each of n¹ and n² represents a number of 5 to 30, preferably 5 to 15, more preferably 6 to 10; n¹ and n² may be identical to or different from each other. Further, each of n³ and n⁴ represents a number of 4 to 24, preferably 4 to 12, more preferably 5 to 10; n³ and n⁴ may be identical to or different from each other.

Furthermore, R independently represents a hydrogen atom, or a linear or branched alkyl or alkenyl group having 4 to 40, preferably 5 to 20, more preferably 6 to 15 carbon atoms. Specific examples of R include a hydrogen atom; a butyl group, a pentyl group, a hexyl group, a heptyl group, an octyl group, a nonyl group, a decyl group, an undecyl group, a lauryl group, a stearyl group, a 3-octenyl group and structural isomers thereof.

Specific examples of the formulae (3-1), (3-2), (4) and (5) include the following structures:

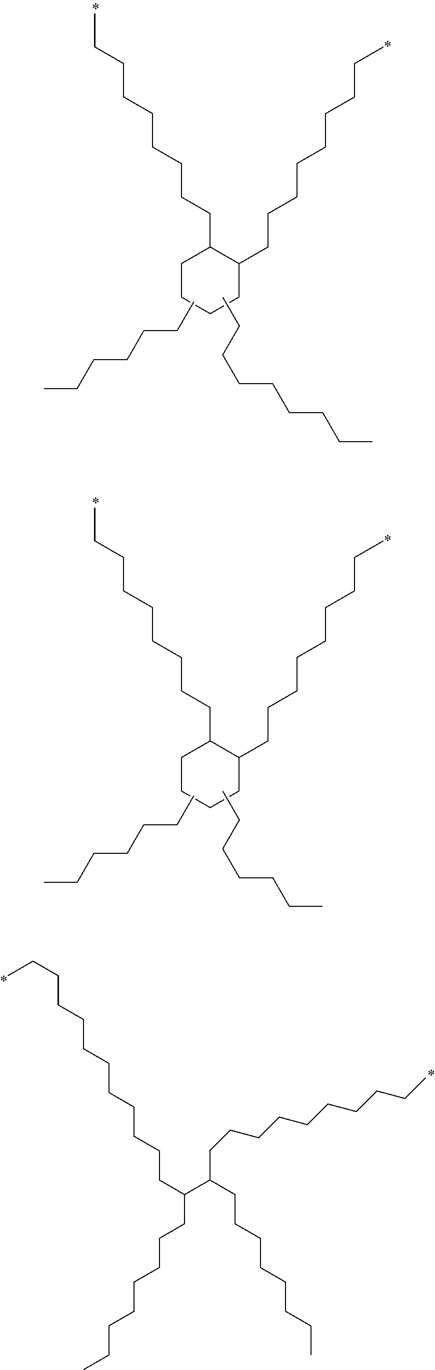

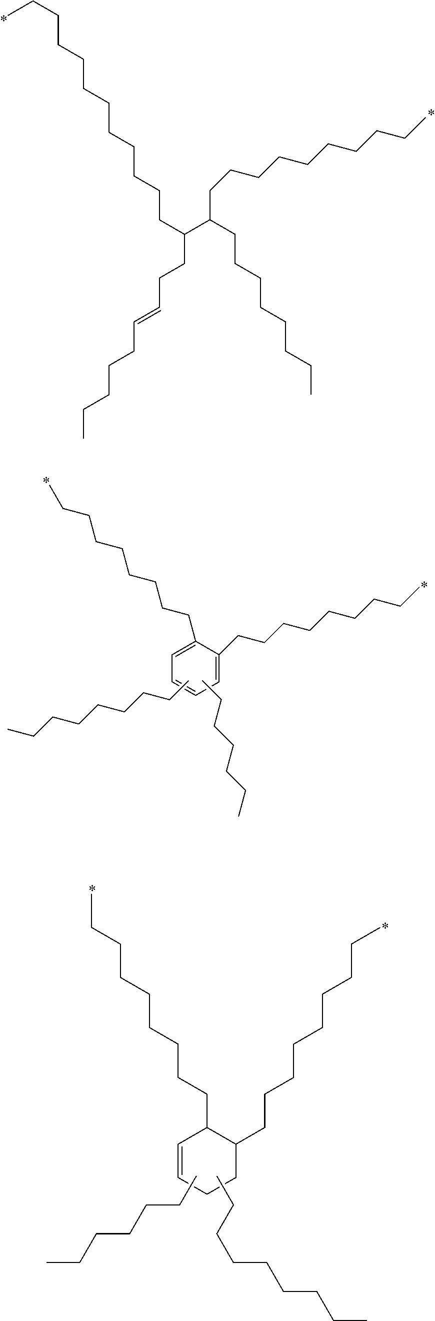

wherein * represents bonding position(s).

Further, in the formula (1), Q independently represents a cyclohexane backbone-containing divalent alicyclic hydrocarbon group having 6 to 60, preferably 8 to 30, more preferably 10 to 20 carbon atoms. Here, Q is independently expressed by the following formula (2):

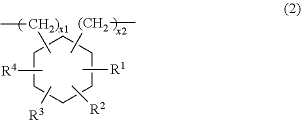

wherein each of R¹, R², R³ and R⁴ independently represents a hydrogen atom or an alkyl group having 1 to 5 carbon atoms; each of x1 and x2 represents a number of 0 to 4.

Here, specific examples of R¹, R², R³ and R⁴ include a hydrogen atom, a methyl group, an ethyl group, an n-propyl group, an isopropyl group, an n-butyl group, an isobutyl group and a t-butyl group. Among these examples, a hydrogen atom and a methyl group are preferred. Particularly, R¹, R², R³ and R⁴ may be identical to or different from another.

Further, each of x1 and x2 represents a number of 0 to 4, preferably a number of 0 to 2. Particularly, x1 and x2 may be identical to or different from each other.

Specific examples of Q in the formula (1) include those having the following structures:

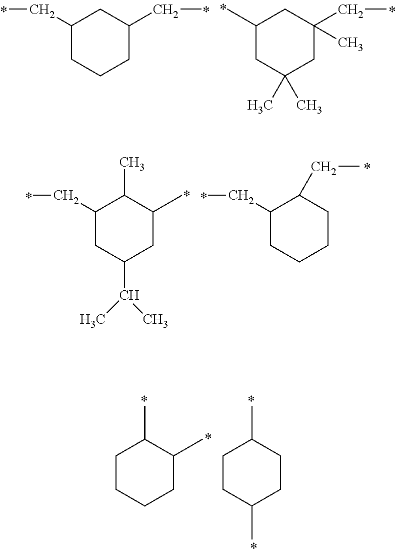

wherein * represents bonding position(s).

In the formula (1), W represents B or Q. Whether W takes the structural unit of either B or Q is determined by a difference(s) in a later-described production method.

In the formula (1), n represents 1 to 100, preferably 1 to 50, more preferably 1 to 40. Furthermore, m represents 0 to 100, preferably 1 to 50, more preferably 1 to 40.

Further, in the maleimide compound represented by the formula (1), there are no restrictions on the order in which the units identified by n and m are repeated; while the bonding pattern of these units may be alternate, block or random, block bonding is preferred.

There are no particular restrictions on a method for producing the maleimide compound as the component (A). The compound may, for example, be efficiently produced by any one of the two methods shown below.

### Production Method 1

A first method for producing the bismaleimide compound includes a step A of synthesizing an amic acid with an acid anhydride represented by the following formula (6) and an alicyclic diamine represented by the following formula (7), and then performing cyclodehydration; a step B subsequent to the step A, which is a step of synthesizing an amic acid with the reactant obtained in the step A and a diamine represented by the following formula (8), and then performing cyclodehydration; and a step C subsequent to the step B, which is a step of synthesizing a maleamic acid with the reactant obtained in the step B and a maleic anhydride, and then performing cyclodehydration to block molecular chain ends with maleimide groups.

### Production Method 2

A second method for producing the bismaleimide compound includes a step A′ of synthesizing an amic acid with the acid anhydride represented by the following formula (6) and the diamine represented by the following formula (8), and then performing cyclodehydration; a step B′ subsequent to the step A′, which is a step of synthesizing an amic acid with the reactant obtained in the step A′ and the alicyclic diamine represented by the following formula (7), and then performing cyclodehydration; and a step C′ subsequent to the step B′, which is a step of synthesizing a maleamic acid with the reactant obtained in the step B′ and a maleic anhydride, and then performing cyclodehydration to block molecular chain ends.

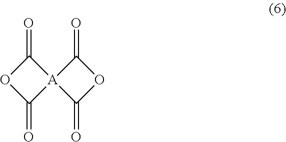

In the formula (6), A represents a tetravalent organic group having a cyclic structure.

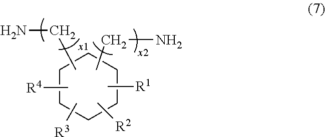

In the formula (7), each of R¹, R², R³ and R⁴ independently represents a hydrogen atom or an alkyl group having 1 to 5 carbon atoms; each of x1 and x2 represents a number of 0 to 4.

H₂N—B—NH₂ (8)

In the formula (8), B represents a divalent hydrocarbon group having 6 to 200 carbon atoms.

Here, specific examples as well as preferable examples of those represented by the symbols in the formulae (6) to (8) are similar to the examples of those represented by the corresponding symbols in the formula (1).

The two production methods have now been described. As a basic pattern, the bismaleimide compound can be obtained by the step A (or step A′) of synthesizing an amic acid with a tetracarboxylic dianhydride and a diamine, and then performing cyclodehydration; the step B (or step B′) subsequent to the step A (or step A′), which is a step of synthesizing an amic acid by adding a diamine other than that employed in the previous step A (or step A′), and then further performing cyclodehydration; and then the step C (or step C′) subsequent to the step B (or step B′), which is a step of reacting a maleic anhydride to synthesize a maleamic acid, and then finally performing cyclodehydration to block molecular chain ends with maleimide groups. The above two production methods mainly differ from each other only in the order in which the different types of diamines are added.

In the above two production methods, the steps can be grouped into two categories which are the synthesis reaction of an amic acid or maleamic acid; and the cyclodehydration reaction. These reactions are described in detail hereunder.

In the step A (or step A′), an amic acid is at first synthesized by reacting a particular tetracarboxylic dianhydride with a particular diamine. This reaction usually proceeds in an organic solvent (e.g. non-polar solvent or high-boiling aprotic polar solvent) and at a temperature of room temperature (25° C.) to 100° C.

Next, the cyclodehydration reaction of the amic acid is performed in a way such that after reacting the amic acid at a temperature of 90 to 120° C., the cyclodehydration reaction is then caused to proceed while removing from the system a water produced as a by-product due to a condensation reaction. An organic solvent (e.g. non-polar solvent, high-boiling aprotic polar solvent) and/or an acid catalyst may also be added to promote the cyclodehydration reaction.

Examples of the organic solvent include toluene, xylene, anisole, biphenyl, naphthalene, N,N-dimethylformamide (DMF) and dimethylsulfoxide (DMSO). Any one of these organic solvents may be used alone, or two or more of them may be used in combination. Further, examples of the acid catalyst include sulfuric acid, methanesulfonic acid and trifluoromethanesulfonic acid. Any one of these acid catalysts may be used alone, or two or more of them may be used in combination.

A molar ratio between the tetracarboxylic dianhydride and the diamine is preferably tetracarboxylic dianhydride/diamine=1.01 to 1.50/1.0, more preferably tetracarboxylic dianhydride/diamine=1.01 to 1.35/1.0. By combining the tetracarboxylic dianhydride and the diamine at this ratio, there can be synthesized, as a result, a copolymer having an imide group at both ends.

In the step B (or step B′), an amic acid is at first synthesized by reacting the copolymer obtained in the step A (or step A′) with a particular diamine, the copolymer being that having an imide group at both ends. This reaction also usually proceeds in an organic solvent (e.g. non-polar solvent or high-boiling aprotic polar solvent) and at a temperature of room temperature (25° C.) to 100° C.

Likewise, the subsequent cyclodehydration reaction of the amic acid is performed in a way such that after reacting the amic acid at a temperature of 95 to 120° C., the cyclodehydration reaction is then caused to proceed while removing from the system a water produced as a by-product due to a condensation reaction. An organic solvent (e.g. non-polar solvent, high-boiling aprotic polar solvent) and/or an acid catalyst may also be added to promote the cyclodehydration reaction.

Examples of the organic solvent include toluene, xylene, anisole, biphenyl, naphthalene, N,N-dimethylformamide (DMF) and dimethylsulfoxide (DMSO). Any one of these organic solvents may be used alone, or two or more of them may be used in combination. Further, examples of the acid catalyst include sulfuric acid, methanesulfonic acid and trifluoromethanesulfonic acid. Any one of these acid catalysts may be used alone, or two or more of them may be used in combination.

A molar ratio between the copolymer having an imide group at both ends and the diamine is preferably 1.0:1.6 to 2.5, more preferably 1.0:1.8 to 2.2.

In the step C (or step C′), a maleamic acid is synthesized by reacting, at a temperature of room temperature (25° C.) to 100° C., a diamine (dual-end diamine compound) having an amino group at both ends with a maleic anhydride, the diamine being that obtained in the step B (or B′). Finally, cyclodehydration is performed while removing from the system a water produced at 95 to 120° C. as a by-product, thereby blocking the molecular chain ends with maleimide groups, thus obtaining the target maleimide compound. It is preferred that the reaction for blocking the molecular chain ends with maleimide groups be performed at a temperature of not higher than 120° C., because side reactions are less likely to occur, and products with higher molecular weights are less likely to be produced.

With such production method(s), the bismaleimide compound obtained shall have the structure of a block copolymer, thereby homogenizing and improving the compatibility of the resin synthesized.

A molar ratio between the diamine having an amino group at both ends and the maleic anhydride is preferably 1.0:1.6 to 2.5, more preferably 1.0:1.8 to 2.2.

In the end, in accordance with a common method, for example, by performing refinement via reprecipitation or the like, there can be obtained the maleimide compound as the component (A).

In resin components of the present invention, it is preferred that the component (A) be present in an amount of 10 to 95% by mass, more preferably 15 to 85% by mass.

### (B) Reaction Promoter

A reaction promoter as a component (B) is added to promote a cross-linking reaction of the maleimide compound as the component (A); and a reaction between the maleimide groups in the component (A) and reactive groups in a later-described component (C) that are reactive with maleimide groups.

There are no particular restrictions on the component (B), as long as it is capable of promoting a cross-linking reaction; examples of the component (B) include ion catalysts such as imidazoles, tertiary amines, quaternary ammonium salts, a boron trifluoride amine complex, organophosphines and organophosphonium salts; organic peroxides such as diallyl peroxide, dialkyl peroxide, peroxide carbonate and hydroperoxide; and radical polymerization initiators such as azoisobutyronitrile. Even among these examples, an organic peroxide and a radical polymerization initiator are preferred if the reaction to be promoted involves the component (A) alone, or if the reactive groups in the component (C) are carbon-carbon double bond-containing groups such as other maleimide groups, alkenyl groups and (meth)acrylic groups; a basic compound(s) such as imidazoles and tertiary amines are preferred if the reactive groups in the component (C) are epoxy groups, hydroxyl groups and/or acid anhydride groups.

The reaction promoter is added in an amount of 0.05 to 10 parts by mass, particularly preferably 0.1 to 5 parts by mass, per 100 parts by mass of a sum of the heat-curable resin components such as the components (A) and (C). It is not preferable if the amount of the reaction promoter is out of the above ranges, because curing may take place extremely slowly or rapidly at the time of molding the maleimide resin composition. Further, if the amount of the reaction promoter is out of the above ranges, a cured product obtained may also exhibit an impaired balance between heat resistance and moisture resistance.

(C) Heat-Curable Resin Having Reactive Group Reactive with Maleimide Group

In the present invention, there may also be added, as a component (C), a heat-curable resin having a reactive group(s) reactive with maleimide groups.

Examples of a reactive group reactive with a maleimide group include an epoxy group; a maleimide group; a hydroxyl group; an acid anhydride group; an alkenyl group such as an allyl group and a vinyl group; a (meth)acrylic group; and a thiol group. However, in a heat-curable resin having maleimide groups as reactive groups, a component equivalent to the maleimide compound as the component (A) shall be excluded from the component (C).

In terms of reactivity, it is preferred that the reactive group(s) in the heat-curable resin as the component (C) be selected from an epoxy group, a maleimide group, a hydroxyl group, an acid anhydride group and an alkenyl group; in terms of dielectric property, it is more preferred that the reactive group be an alkenyl group or a (meth)acrylic group.

As such heat-curable resin, there are no restrictions on the type thereof, examples of which may include an epoxy resin, a phenolic resin, a melamine resin, a silicone resin, a cyclic imide resin, a urea resin, a heat-curable polyimide resin, a modified polyphenylene ether resin, a heat-curable acrylic resin and an epoxy-silicone hybrid resin; a modified polyphenylene ether resin is preferred.

It is preferred that the number average molecular weight of the heat-curable resin as the component (C) be 350 to 6,000, more preferably 1,000 to 5,000.

As for the component (C), there may be used only one kind thereof, or two or more kinds thereof may be used in combination.

It is preferred that the component (C) be added in an amount of 5 to 90% by mass, more preferably 15 to 85% by mass, per 100% by mass of the resin components.

### (D) Inorganic Filler

In the present invention, in addition to the components (A) to (C), there may be further added an inorganic filler as a component (D). The inorganic filler as the component (D) may be added for the purpose of, for example, improving the strength and rigidity of the cured product of the heat-curable maleimide resin composition of the present invention, or adjusting a thermal expansion coefficient and a dimension stability of the cured product. As the inorganic filler as the component (D), there may be used those that are normally added to an epoxy resin composition or a silicone resin composition. Examples of such inorganic filler include silicas such as a spherical silica, a molten silica and a crystalline silica; alumina; silicon nitride; aluminum nitride; boron nitride; barium sulfate; talc; clay; aluminum hydroxide; magnesium hydroxide; calcium carbonate; glass fibers; and glass particles. Further, in order to improve a dielectric property, there may be used a fluorine resin-containing or -coated filler; and/or hollow particles. Furthermore, in order to, for example, impart an electrical conductivity, there may also be added an electrically conductive filler(s) such as metal particles, metal-coated inorganic particles, carbon fibers and carbon nanotubes.

As for the inorganic filler as the component (D), there may be used only one kind thereof, or two or more kinds thereof may be used in combination.

While there are no particular restrictions on the average particle size or shape of the inorganic filler as the component (D), a spherical silica having an average particle size of 0.5 to 5 μm is especially preferably used if forming a film or a substrate. Here, the term “average particle size” refers to a value obtained as a mass average value D50 (or median diameter) in particle size distribution measurement that is carried out by a laser light diffraction method.

Moreover, it is preferred that the inorganic filler as the component (D) be such an inorganic filler that has already been surface-treated by a silane coupling agent having an organic group(s) reactive with the maleimide groups in the component (A) and the reactive groups in the heat-curable resin as the component (C). Examples of such coupling agent include an epoxy group-containing alkoxysilane, an amino group-containing alkoxy silane, a (meth)acrylic group-containing alkoxysilane and an alkenyl group-containing alkoxysilane.

As the above coupling agent, a (meth)acrylic group- and/or amino group-containing alkoxy silane is preferably used, examples of which include 3-methacryloxypropyltrimethoxysilane, 3-acryloxypropyltrimethoxysilane, N-phenyl-3-aminopropyltrimethoxysilane, N-2-(aminoethyl)-3-aminopropyltrimethoxysilane and 3-aminopropyltrimethoxysilane.

These coupling agents are not only able to lower the viscosity and thixotropic property of a resin composition before curing, or improve a mechanical strength and dielectric property of the cured product; but are also able to bring about an effect of improving an adhesiveness to a metal such as copper.

Any one kind of these coupling agents may be used alone, or two or more kinds thereof may be used in combination.

While there are no particular restrictions on the amount of the inorganic filler as the component (D) added, it is preferred that the inorganic filler(s) be added in an amount of 20 to 400 parts by mass, particularly preferably 50 to 300 parts by mass, per 100 parts by mass of the sum of the heat-curable resin components comprised of the components (A) and/or (C), in the case of film or substrate uses. When the amount of the inorganic filler as the component (D) added is not smaller than 20 parts by mass but smaller than 400 parts by mass, the cured product will exhibit a small coefficient of thermal expansion (CTE) so that a sufficient strength can be achieved, a flexibility as that of a film will not be lost, and a poor appearance will not occur. Further, if the amount of the inorganic filler is within this range, an adhesive force can also be maintained at a high value. Here, it is preferred that this inorganic filler be contained in the whole composition by an amount of 10 to 80% by mass, particularly preferably 15 to 75% by mass.

### Other Additives

If necessary, various additives may further be added to the heat-curable maleimide resin composition of the present invention without impairing the effects of the present invention. Examples of such additives include a reactive functional group-containing organopolysiloxane, a non-functional silicone oil, a thermoplastic resin, a thermoplastic elastomer, an organic synthetic rubber, a photosensitizer, a light stabilizer, a polymerization inhibitor, a flame retardant, a colorant, a dye and an adhesion aid. Further, in order to improve an electric property of the cured product of the heat-curable maleimide resin composition, there may be added, for example, an ion trapping agent as one of those other additives.

The heat-curable maleimide resin composition of the present invention may also be treated as a varnish after being dissolved in an organic solvent. When in the state of a varnish, the heat-curable maleimide resin composition is easier to be molded into the shape of a sheet or film, and is easier to be applied to or impregnate a glass cloth made of, for example, an E glass, a low-dielectric glass or a quartz glass. There are no restrictions on the organic solvent, as long as it is capable of dissolving the heat-curable resin components such as the components (A) and (C). As such organic solvent, there may be preferably used, for example, toluene, xylene, anisole, cyclohexanone or cyclopentanone. As for the above organic solvents, one kind thereof may be used alone, or two or more kinds thereof may be used in a mixed manner. It is preferred that a concentration of the heat-curable maleimide resin composition of the present invention in the varnish be 5 to 80% by mass, more preferably 10 to 75% by mass.

This heat-curable maleimide resin composition can be used as an adhesive agent; a primer; a coating material for use in semiconductor devices, etc.; as well as a material for a substrate. The heat-curable maleimide resin composition may be used by any method and in any state when used. Examples of use include, but are not limited to the following examples.

For example, the heat-curable maleimide resin composition dissolved in the organic solvent (i.e. varnish) may be applied to a base material, followed by performing heating at a temperature of normally not lower than 80° C., preferably not lower than 100° C. for 0.5 to 5 hours so as to remove the organic solvent, and then performing another round of heating at a temperature of not lower than 150° C., preferably not lower than 175° C. for 0.5 to 10 hours so as to form a strong maleimide resin cured film having a flat surface. While a constant temperature may be used in each of the drying step for removing the organic solvent and the subsequent heat curing step, it is preferred that the temperature be raised in a stepwise manner. In this way, the organic solvent can be efficiently eliminated from the composition, and the curing reaction of the resin can take place efficiently as well.

In addition to the cured film obtained by curing the heat-curable maleimide resin composition of the present invention being superior in heat resistance, mechanical properties, electric properties, adhesion to base materials, and solvent resistance, the cured film also has a low permittivity. Thus, this cured film can be utilized as, for example, a film for use in a semiconductor device, specifically a passivation film or protective film provided on the surface of a semiconductor element; a junction protective film for use in junction areas of, for example, a diode and a transistor; and an α-ray shielding film, interlayer insulation film and ion implantation mask for a VLSI. Other than these purposes, the cured film may also be utilized as a conformal coating film for a printed circuit board, an oriented film for an LCD element, a protective film for glass fibers, and a surface protective film for a solar cell. Further, the heat-curable maleimide resin composition of the present invention may be utilized for a wide range of purposes such as that of a paste composition, in a sense that, for example, if containing an inorganic filler(s), the composition can be used as a paste composition for printing; and if containing an electrically conductive filler(s), the composition may be used as an electrically conductive paste composition.

Examples of a method for applying the heat-curable maleimide resin composition dissolved in the organic solvent to a base material include, but are not particularly limited to methods using a spin coater, a slit coater, a sprayer, a dip coater or a bar coater.

Further, by molding an epoxy resin molding material for semiconductor encapsulation after forming the aforementioned cured film, an adhesiveness between the epoxy resin molding material for semiconductor encapsulation and the base material can be improved. A semiconductor device obtained in this manner has a high reliability in that cracks in the epoxy resin molding material for semiconductor encapsulation as well as peeling thereof from the base material shall not be observed during a solder reflow process after moisture absorption.

In this case, as the epoxy resin molding material for semiconductor encapsulation, there may be used an epoxy resin having at least two epoxy groups in one molecule; a phenolic resin; a curing agent for epoxy resin, such as an acid anhydride; and a known epoxy resin composition for semiconductor encapsulation that contains an inorganic filler or the like. A commercially available epoxy resin molding material for semiconductor encapsulation may also be used.

Here, if the base material employs an easily oxidizable metal such as copper, it is preferred that an environment under which the heat-curable maleimide resin composition of the present invention and the epoxy resin molding material for semiconductor encapsulation are to be actually cured be that of a nitrogen atmosphere for oxidation prevention.

In addition, the resin composition of the present invention may also be applied to a supporting sheet and then used in the form of a film. The supporting sheet may be a generally used supporting sheet, examples of which include those made of polyolefin resins such as polyethylene (PE) resin, polypropylene (PP) resin and polystyrene (PS) resin; and polyester resins such as polyethylene terephthalate (PET) resin, polybutylene terephthalate (PBT) resin and polycarbonate (PC) resin. The surfaces of these supporting sheets may be those that have already been subjected to a mold release treatment. Further, there are no particular restrictions on a coating method, examples of which may include methods using a gap coater, a curtain coater, a roll coater or a laminator. Furthermore, there are no particular restrictions on the thickness of a coating layer; a thickness after removing the solvent is in a range of 1 to 100 μm, preferably 3 to 80 μm. A cover film may further be provided on the coating layer.

Moreover, a copper foil may be attached to the coating layer so that the copper foil can thus be turned into a resin-attached copper foil and used as a substrate material.

Further, the resin composition in the state of a varnish may be used to impregnate, for example, a glass cloth made of, for example, an E glass, a low-dielectric glass or a quartz glass, followed by removing the organic solvent so as to reach the B-stage, thereby allowing the composition to be used as a prepreg.

### Working Examples

The present invention is described in detail hereunder with reference to working and comparative examples. However, the present invention is not limited to the following working examples.

Components used in working and comparative examples are shown below. Here, a number average molecular weight (Mn) is measured under the following measurement condition.

Developing solvent: Tetrahydrofuran
Flow rate: 0.35 mL/min

### Detector: RI

Column: TSK-GEL H type (by TOSOH CORPORATION)
Column temperature: 40° C.
Sample injection volume: 5 μL

### Synthesis Example 1 (Production of Bismaleimide Compound, Reaction Formula 1)

Isophoronediamine of 37.25 g (0.219 mol), pyromellitic dianhydride of 76.94 g (0.35 mol) and toluene of 350 g were added to a 2 L glass four-necked flask equipped with a stirrer, a Dean-Stark tube, a cooling condenser and a thermometer, followed by stirring them at 80° C. for three hours to synthesize an amic acid. Next, the temperature was directly raised to 110° C., and stirring was performed for another four hours while distilling away a water produced as a by-product, thereby synthesizing a block copolymer having an imide group at both ends.

Later, 116.88 g (0.219 mol) of Priamine-1075 (by CRODA, a diamine compound expressed by H₂N—C₃₆H₇₀—NH₂ (average composition formula) and containing a dimer diamine represented by the following formulae (3′) to (5′)) was added to the flask containing the solution of the block copolymer having an imide group at both ends, the solution having been cooled to room temperature. Stirring was then performed at 80° C. for three hours to synthesize an amic acid. Next, the temperature was directly raised to 110° C., and stirring was performed for another four hours while distilling away a water produced as a by-product, thereby synthesizing a dual-end diamine compound.

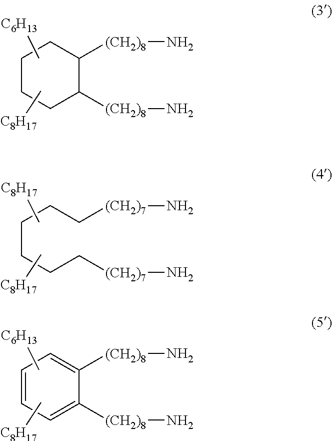

After cooling the flask containing the dual-end diamine compound solution obtained to room temperature, 18.88 g (0.193 mol) of maleic anhydride was added thereto, followed by heating the flask again and performing stirring at 80° C. for three hours to synthesize an amic acid. Next, the temperature was directly raised to 110° C., and stirring was performed for another 15 hours while distilling away a water produced as a by-product, followed by performing washing with 300 g of water five times so as to obtain a varnish of a bismaleimide compound. Later, a reprecipitation step was carried out by delivering the varnish into 3,000 g of isopropyl alcohol (IPA) by drops, followed by removing the solvent and then performing drying so as to obtain a target seal brown solid (A-1) (number average molecular weight: 8,000).

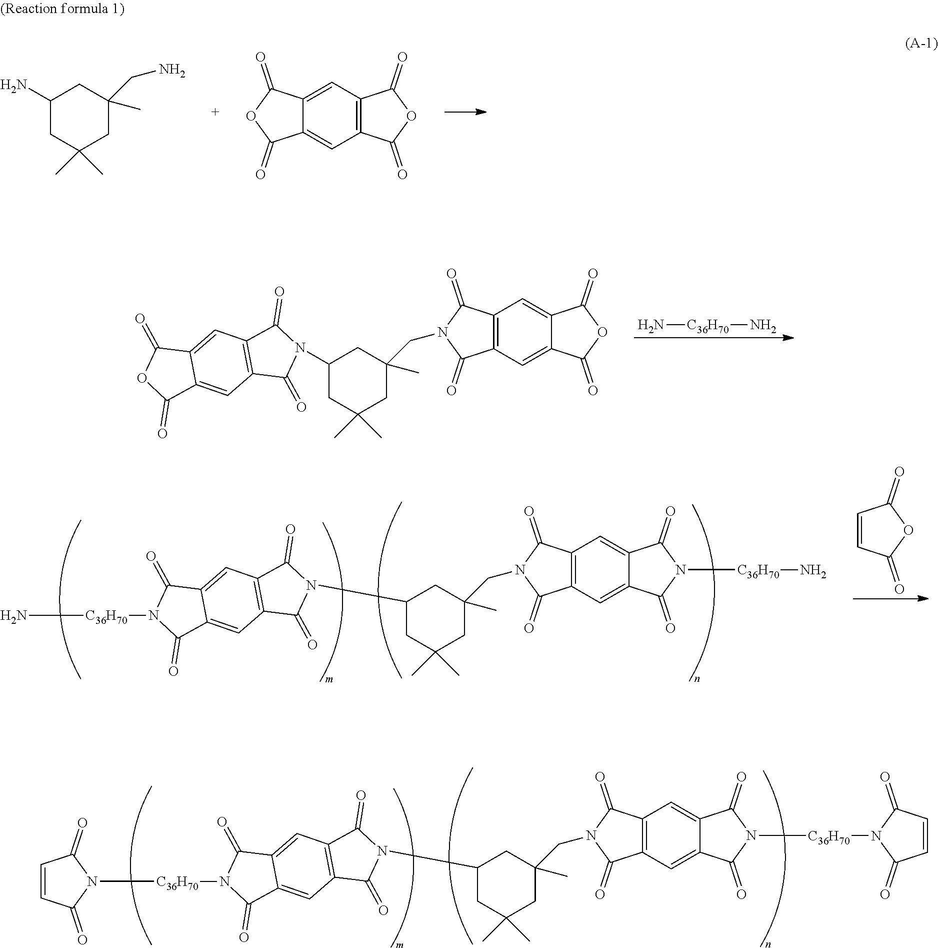

H₂N—C₃₆H₇₀—NH₂ represents Priamine-1075
n≈3, m≈1 (both are average values)

### Synthesis Example 2 (Production of Bismaleimide Compound, Reaction Formula 2)

1,3-bisaminomethylcyclohexane of 31.13 g (0.219 mol), pyromellitic dianhydride of 76.94 g (0.35 mol) and toluene of 350 g were added to a 2 L glass four-necked flask equipped with a stirrer, a Dean-Stark tube, a cooling condenser and a thermometer, followed by stirring them at 80° C. for three hours to synthesize an amic acid. Next, the temperature was directly raised to 110° C., and stirring was performed for another four hours while distilling away a water produced as a by-product, thereby synthesizing a block copolymer having an imide group at both ends.

Later, 116.88 g (0.219 mol) of Priamine-1075 (by CRODA, a diamine compound expressed by H₂N—C₃₆H₇₀—NH₂ (average composition formula) and containing a dimer diamine represented by the above formulae (3′) to (5′)) was added to the flask containing the solution of the block copolymer having an imide group at both ends, the solution having been cooled to room temperature. Stirring was then performed at 80° C. for three hours to synthesize an amic acid. Next, the temperature was directly raised to 110° C., and stirring was performed for another four hours while distilling away a water produced as a by-product, thereby synthesizing a dual-end diamine compound.

After cooling the flask containing the dual-end diamine compound solution obtained to room temperature, 18.88 g (0.193 mol) of maleic anhydride was added thereto, followed by heating the flask again and performing stirring at 80° C. for three hours to synthesize an amic acid. Next, the temperature was directly raised to 110° C., and stirring was performed for another 15 hours while distilling away a water produced as a by-product, followed by performing washing with 300 g of water five times so as to obtain a varnish of a maleimide compound. Later, a reprecipitation step was carried out by delivering the varnish into 2,000 g of IPA by drops, followed by removing the solvent and then performing drying so as to obtain a target seal brown solid (A-2) (number average molecular weight: 7,600).

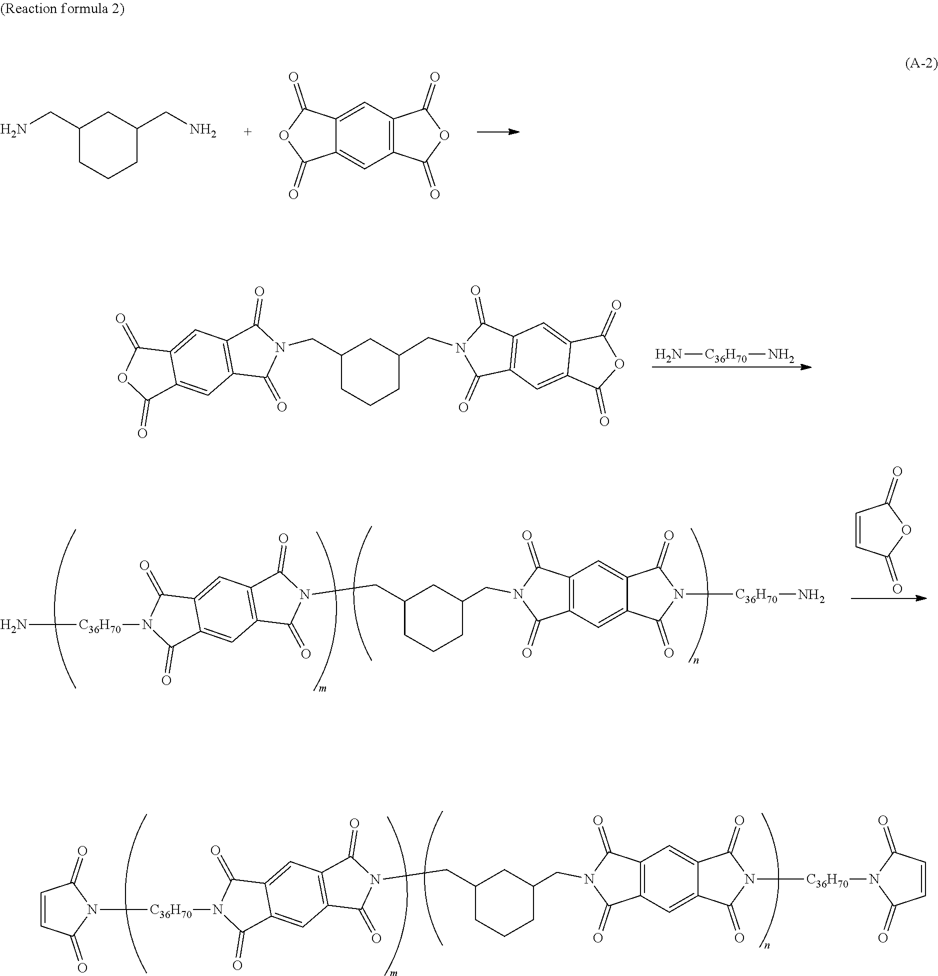

H₂N—C₃₆H₇₀—NH₂ represents Priamine-1075
n≈3, m≈1 (both are average values)

### (B) Reaction Promoter

(B-1) Dicumylperoxide (PERCUMYL D by NOF CORPORATION)

(B-2) Imidazole-based curing accelerator (1B2PZ by SHIKOKU CHEMICALS CORPORATION)

(C-1): Linear alkylene group-containing bismaleimide compound represented by the following formula (BMI-3000) by Designer Molecules Inc.; Mn 7,000)

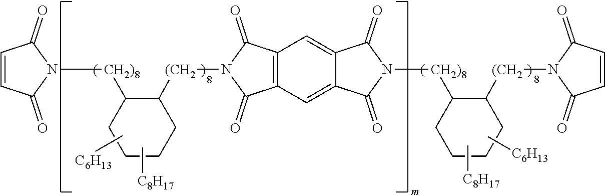

m≈3 (average value)

(C-2) Linear alkylene group-containing bismaleimide compound represented by the following formula (BMI-2500 by Designer Molecules Inc.; Mn 4,500)

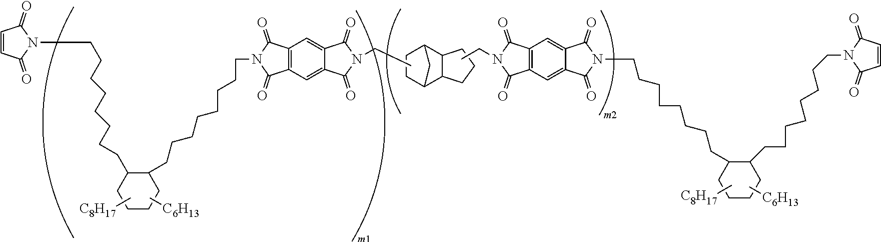

m1≈3, m2≈3 (both are average values)

(C-3) Solid bisphenol A-type epoxy resin (jER-1001 by Mitsubishi Chemical Corporation; epoxy equivalent 475)

(C-4) Terminal styrene-modified polyphenylene ether resin represented by the following formula (OPE-2St-1200 by Mitsubishi Gas Chemical Company, Inc.; number average molecular weight 1,200)

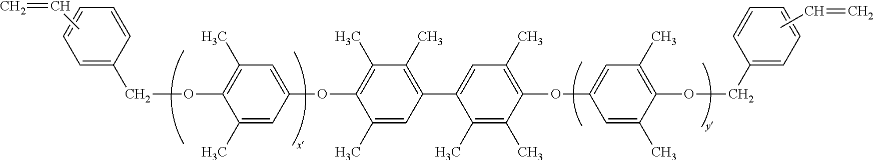

wherein x′ represents 0 to 20, y′ represents 0 to 20, provided that x′ and y′ shall not both represent 0 at the same time.

(C-5) 4,4′-diphenylmethanebismaleimide (BMI-1000 by Daiwa Fine Chemicals Co., Ltd.)

### (D) Inorganic Filler

(D-1) Silica prepared by treating molten spherical silica (SO-25R by Admatechs Company Limited; average particle size 0.5 μm) with methacrylic group-modified silane coupling agent (KBM-503 by Shin-Etsu Chemical Co., Ltd.)

### Working Examples 1 to 10; Comparative Examples 1 to 10

Components were dissolved and dispersed in anisole at the compounding ratios (parts by mass) shown in Tables 1 and 2, followed by making an adjustment so that a non-volatile content would be in an amount of 60% by mass, thereby obtaining a varnish of a resin composition (varnish 1). A roller coater was then used to apply the resin composition varnish 1 to a PET film having a thickness of 38 followed by performing drying at 80° C. for 15 min so as to obtain an uncured resin film having a thickness of 50 In the following evaluation test, the uncured resin film was used after peeling the PET film therefrom, the uncured resin film being originally formed on such PET film as described above.

### Varnish Transparency

An anisole solution was prepared at the compounding ratios shown in Tables 1 and 2, except that the component (D) was not used. The solution was then turned into a varnish having a non-volatile content of 60% by mass (varnish 2). The transparency of the varnish 2 prepared was evaluated based on the two conditions below where “o” was given when both conditions were met, whereas “x” was given if not.
No visible insoluble residues and turbidity were observed.
Varnish 2 was put into a quartz cell, a spectrophotometer U-4100 (by Hitachi High-Tech Science Corporation) was used to measure a direct light transmittance at a light path of 1 mm and a wavelength of 740 nm, the direct light transmittance measured was not lower than 50%.

### Appearance of Cured Film

A test press machine (KVHC) manufactured by KITAGAWA SEIKI CO., LTD was used to cure the uncured resin film in a stepwise manner where the resin film was at first treated at 150° C. for an hour, and then at 180° C. for another two hours. The appearance of a cured resin film thus obtained was visually confirmed. “∘” was given when no curing unevenness was observed and the color of the entire film was even; “x” was given when curing unevenness or separation was observed and the color of the film was locally different.

### Relative Permittivity, Dielectric Tangent

A test press machine (KVHC) manufactured by KITAGAWA SEIKI CO., LTD was used to cure the uncured resin film in a stepwise manner where the resin film was at first treated at 150° C. for an hour, and then at 180° C. for another two hours, thereby obtaining a cured resin film. Next, a network analyzer (E5063-2D5 by Keysight Technologies) and a stripline (by KEYCOM Corporation) were connected to the cured resin film to measure a relative permittivity and a dielectric tangent thereof at a frequency of 10 GHz.

### Glass-Transition Temperature

A test press machine (KVHC) manufactured by KITAGAWA SEIKI CO., LTD was used to cure the uncured resin film in a stepwise manner where the resin film was at first treated at 150° C. for an hour, and then at 180° C. for another two hours, thereby obtaining a cured resin film. After cooling such cured resin film to 25° C., DMA-800 manufactured by TA Instruments, Inc. was used to measure a glass-transition temperature (Tg) of the cured resin film.

### Adhesive Force to Copper Foil

At first, the uncured resin film was laminated on an E glass plate of a size of length 80 mm×width 25 mm×thickness 1 mm, at 80° C. Next, a 12 μm-thick electrolytic copper foil (MLS-G by MITSUI MINING&SMELTING CO., LTD.) was placed on the surface of the glass plate on which the uncured resin film had been laminated, followed by performing vacuum pressing at a pressure of 30 kg/cm² and a temperature of 180° C. for 120 min, thereby obtaining a copper-clad laminate adhering to the glass plate via the cured resin film. With the glass plate part being fixed, the copper foil was then peeled for the measurement of a peeling strength in accordance with a method described in JIS C 6481:1996; the peeling strength measured was regarded as an adhesive force between the copper foil and the resin.

TABLE 1

| | | | | Working examples | | | | | | | | | |
|---|---|---|---|---|---|---|---|---|---|---|---|---|---|
| Composition table (part by mass) | | | | 1 | 2 | 3 | 4 | 5 | 6 | 7 | 8 | 9 | 10 |
| (A) | Maleimide | Synthesis | A-1 | 100.0 | | 100.0 | | 70.0 | 70.0 | 70.0 | 30.0 | | 70.0 |
| | compound | example 1 | | | | | | | | | | | |
| | | Synthesis | A-2 | | 100.0 | | 100.0 | | | | | 70.0 | |
| | | example 2 | | | | | | | | | | | |
| (B) | Reaction | PERCUMYL D | B-1 | 2.0 | 2.0 | 2.0 | 2.0 | 2.0 | | 2.0 | 2.0 | 2.0 | 2.0 |
| | promoter | 1B2PZ | B-2 | | | | | | 1.0 | | | | |
| (C) | Heat- | SLK-3000 | C-1 | | | | | 30.0 | | | | | |
| | curable | SLK-2500 | C-2 | | | | | | | | | | |
| | resin | jER-1001 | C-3 | | | | | | 30.0 | | | | |
| | | OPE-2St-1200 | C-4 | | | | | | | 30.0 | 70.0 | 30.0 | |
| | | BMI-1000 | C-5 | | | | | | | | | | 30.0 |
| (D) | Inorganic | Treated | D-1 | | | 100.0 | 100.0 | 100.0 | 100.0 | 100.0 | 100.0 | 100.0 | 100.0 |
| | filler | silica | | | | | | | | | | | |

| | | | | | | | | | | | | |
|---|---|---|---|---|---|---|---|---|---|---|---|---|
| Property | Varnish transparency | | ∘ | ∘ | ∘ | ∘ | ∘ | ∘ | ∘ | ∘ | ∘ | ∘ |
| evaluation | Appearance of cured film | | ∘ | ∘ | ∘ | ∘ | ∘ | ∘ | ∘ | ∘ | ∘ | ∘ |
| | Dielectric tangent (10 GHz) | | 2.5 | 2.4 | 2.8 | 2.8 | 2.7 | 3.4 | 2.9 | 3.0 | 2.9 | 3.1 |
| | Dielectric tangent (10 GHz) | | 0.002 | 0.003 | 0.001 | 0.002 | 0.001 | 0.005 | 0.002 | 0.003 | 0.003 | 0.004 |
| | Glass-transition | ° C. | 145 | 139 | 145 | 139 | 120 | 145 | 160 | 200 | 155 | 168 |
| | temperature (DMA) | | | | | | | | | | | |
| | Adhesive force to copper foil | kN/m | 1.3 | 1.2 | 1.0 | 0.9 | 1.1 | 0.8 | 0.9 | 0.7 | 0.9 | 0.8 |

TABLE 2

| | | | | Comparative examples | | | | | |
|---|---|---|---|---|---|---|---|---|---|
| Composition table (part by mass) | | | | 1 | 2 | 3 | 4 | 5 | 6 |
| (A) | Maleimide compound | Synthesis example 1 | A-1 | | | | | | |
| | | Synthesis example 2 | A-2 | | | | | | |
| (B) | Reaction promoter | PERCUMYL D | B-1 | 2.0 | 2.0 | 2.0 | 2.0 | | 2.0 |
| | | 1B2PZ | B-2 | | | | | 1.0 | |
| (C) | Heat-curable resin | SLK-3000 | C-1 | 100.0 | 100.0 | | 50.0 | | |
| | | SLK-2500 | C-2 | | | 100.0 | 50.0 | | |
| | | jER-1001 | C-3 | | | | | 100.0 | |
| | | OPE-2St-1200 | C-4 | | | | | | 100.0 |
| | | BMI-1000 | C-5 | | | | | | |
| (D) | Inorganic filler | Treated silica | D-1 | | 100.0 | 100.0 | 100.0 | 100.0 | 100.0 |

| | | | | | | | | |
|---|---|---|---|---|---|---|---|---|
| Property | Varnish transparency | | ∘ | ∘ | ∘ | x | ∘ | ∘ |
| evaluation | Appearance of cured film | | ∘ | ∘ | ∘ | x | ∘ | ∘ |
| | Dielectric tangent (10 GHz) | | 2.4 | 2.7 | 2.9 | 2.8 *1 | 3.5 | 3.0 |
| | Dielectric tangent (10 GHz) | | 0.002 | 0.002 | 0.003 | 0.002 *1 | 0.016 | 0.004 |
| | Glass-transition temperature (DMA) | ° C. | 42 | 45 | 135 | *2 | 145 | 221 |
| | Adhesive force to copper foil | kN/m | 1.3 | 1.0 | 0.4 | 0.8 | 0.3 | <0.1 |

| | | | | Comparative examples | | | |
|---|---|---|---|---|---|---|---|
| Composition table (part by mass) | | | | 7 | 8 | 9 | 10 |
| (A) | Maleimide compound | Synthesis example 1 | A-1 | | | | |
| | | Synthesis example 2 | A-2 | | | | |
| (B) | Reaction promoter | PERCUMYL D | B-1 | 2.0 | 2.0 | 2.0 | 2.0 |
| | | 1B2PZ | B-2 | | | | |
| (C) | Heat-curable resin | SLK-3000 | C-1 | 70.0 | | 70.0 | |
| | | SLK-2500 | C-2 | | 70.0 | | |
| | | jER-1001 | C-3 | | | | |
| | | OPE-2St-1200 | C-4 | 30.0 | 30.0 | | |
| | | BMI-1000 | C-5 | | | 30.0 | 100.0 |
| (D) | Inorganic filler | Treated silica | D-1 | 100.0 | 100.0 | 100.0 | 100.0 |

| | | | | | | |
|---|---|---|---|---|---|---|
| Property | Varnish transparency | | x | x | x | ∘ |
| evaluation | Appearance of cured film | | x | x | x | ∘ |
| | Dielectric tangent (10 GHz) | | 2.8 | 2.9 | 3.0 *1 | 3.2 |
| | Dielectric tangent (10 GHz) | | 0.002 | 0.003 | 0.006 *1 | 0.008 |
| | Glass-transition temperature (DMA) | ° C. | *2 | *2 | *2 | 213 |
| | Adhesive force to copper foil | kN/m | 0.8 | 0.2 | 0.5 | 0.2 |

*1: Due to curing unevenness, dielectric property values measured varied depending on measurement sites; the dielectric property value listed is an average value of values measured at five different measurement sites.
*2: Reading of a measurement value of glass-transition temperature was unclear; or multiple glass-transition temperatures were exhibited.

### Measurement of Adhesive Force to Substrate

With regard to compositions obtained in working examples 1 and 2; and a composition obtained in comparative example 1, adhesive forces thereof to a nickel-plated or nickel-palladium-gold-plated copper substrate were evaluated by the following method so as to verify a primer capability of these compositions. For comparison, the evaluation results are shown in Table 3 together with results obtained after measuring the adhesive forces in a similar manner without using the composition of any of the working and comparative examples as a primer.

The composition (varnish 1) obtained in the working example 1, working example 2 or comparative example 1 was sprayed onto a frame substrate prepared by individually plating a 20 mm×20 mm copper frame, followed by performing curing in a stepwise manner where the composition was at first treated at 100° C. for an hour, and then at 180° C. for another two hours, thereby obtaining a cured film.

On such cured film, an epoxy resin molding material for semiconductor encapsulation KMC-2284 produced by Shin-Etsu Chemical Co., Ltd. was then molded into a cylindrical shape having a base area of 10 mm² and a height of 3 mm (molding condition: 175° C.×120 sec×6.9 MPa), followed by performing post curing at 180° C. for four hours to obtain a test specimen for adhesive force measurement. The adhesive force of this test specimen for adhesive force measurement at room temperature was measured by flicking the test specimen with a universal bond tester (DAGE SERIES 4000 by Nordson Corporation) at a rate of 0.2 mm/sec.

Further, in order to verify a reflow resistance, a test specimen for adhesive force measurement was produced by a method similar to the method described above, and an adhesive force thereof at room temperature after being subjected to 260° C. IR reflow three times was then measured by flicking the test specimen with the universal bond tester at the rate of 0.2 mm/sec.

TABLE 3

| | | Working | Working | Comparative | No |
|---|---|---|---|---|---|
| | | example 1 | example 2 | example 1 | primer |
| Adhesive force to nickel | Before reflow | 22.3 | 19.8 | 21.0 | 0.0 |
| plating [MPa] | After reflow | 21.0 | 19.5 | 9.2 | 0.0 |
| Adhesive force to nickel- | Before reflow | 18.9 | 16.9 | 18.8 | 5.2 |
| palladium-gold plating [MPa] | After reflow | 19.2 | 16.9 | 11.5 | 1.2 |

### Prepreg Property

As for compositions obtained in working examples 3 and 5; and comparative examples 5 and 7, prepregs thereof were produced to verify the dielectric properties thereof. The results are shown in Table 4.

After impregnating a quartz glass cloth (Q2116 by Shin-Etsu Chemical Co., Ltd.; thickness 0.1 mm) with each of the compositions (varnishes 1) obtained in the working examples 3 and 5 as well as comparative examples 5 and 7, drying was performed at 120° C. for 5 min to obtain a prepreg(s). There, adjustments were made so that an amount of the components (A) to (D) attached would be 44% by mass. Next, the test press machine (KVHC) manufactured by KITAGAWA SEIKI CO., LTD was used to cure the prepreg obtained in a stepwise manner where the prepreg was at first treated at 150° C. for an hour, and then at 180° C. for another two hours, thereby obtaining a cured resin-impregnated prepreg. Later, the network analyzer (E5063-2D5 by Keysight Technologies) and the stripline (by KEYCOM Corporation) were connected to the cured resin-impregnated prepreg to measure a relative permittivity and a dielectric tangent thereof at the frequency of 10 GHz.

TABLE 4

| | Working | Working | Comparative | Comparative | Quartz cloth |
|---|---|---|---|---|---|
| | example 3 | example 5 | example 5 | example 7 | only |
| Prepreg appearance | ◯ | ◯ | ◯ | X | — |
| Relative permittivity (10 GHz) | 3.0 | 3.0 | 3.6 | 3.1 | 3.7 |
| Dielectric tangent (10 GHz) | 0.0014 | 0.0016 | 0.0108 | 0.0016*3 | 0.0002 |

*3Due to curing unevenness, dielectric property values measured varied depending on measurement sites; the dielectric property value listed is an average value of values measured at five different measurement sites.

Based on the above results, it was confirmed that the composition of the present invention is suitable for use in, for example, an adhesive agent, a substrate material, a primer, a coating material and a semiconductor device, since the cured product of the composition has a high glass-transition temperature, excellent dielectric properties and a superior adhesiveness to a metal foil, and since the composition can be evenly cured with no curing unevenness at the time of curing due to its favorable compatibility with other resins.

What is claimed is:

1. A heat-curable maleimide resin composition comprising:
(A) a maleimide compound represented by the following formula (1) and having a number average molecular weight of 3,000 to 50,000, 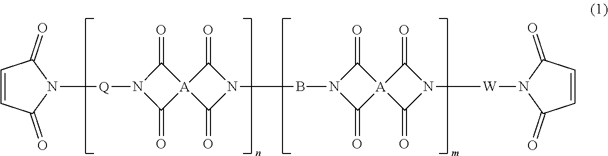
wherein A independently represents a tetravalent organic group having a cyclic structure, B independently represents a divalent hydrocarbon group having 6 to 200 carbon atoms, Q independently represents a cyclohexane backbone-containing divalent alicyclic hydrocarbon group having 6 to 60 carbon atoms, W represents B or Q, n represents 1 to 100, m represents 0 to 100, repeating units identified by n and m are present in any order, a bonding pattern of the repeating units n and m may be alternate, block or random, and
wherein Q is independently represented by the following formula (2): 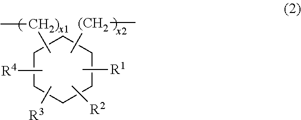
wherein each of R¹, R², R³ and R⁴ independently represents a hydrogen atom or an alkyl group having 1 to 5 carbon atoms, each of x1 and x2 represents a number of 0 to 4; and
(B) a reaction promoter.

2. The heat-curable maleimide resin composition according to claim 1, further comprising:
(C) a heat-curable resin having, as a reactive group(s) reactive with maleimide groups, at least one kind of group selected from an epoxy group, a maleimide group, a hydroxyl group, an acid anhydride group, an alkenyl group, a (meth)acrylic group and a thiol group.

3. The heat-curable maleimide resin composition according to claim 1, wherein the bonding pattern of the repeating units identified by n and m is block in the alicyclic backbone-containing maleimide compound represented by the formula (1).

4. The heat-curable maleimide resin composition according to claim 1, wherein A in the formula (1) represents any one of the tetravalent organic groups expressed by the following structural formulae: 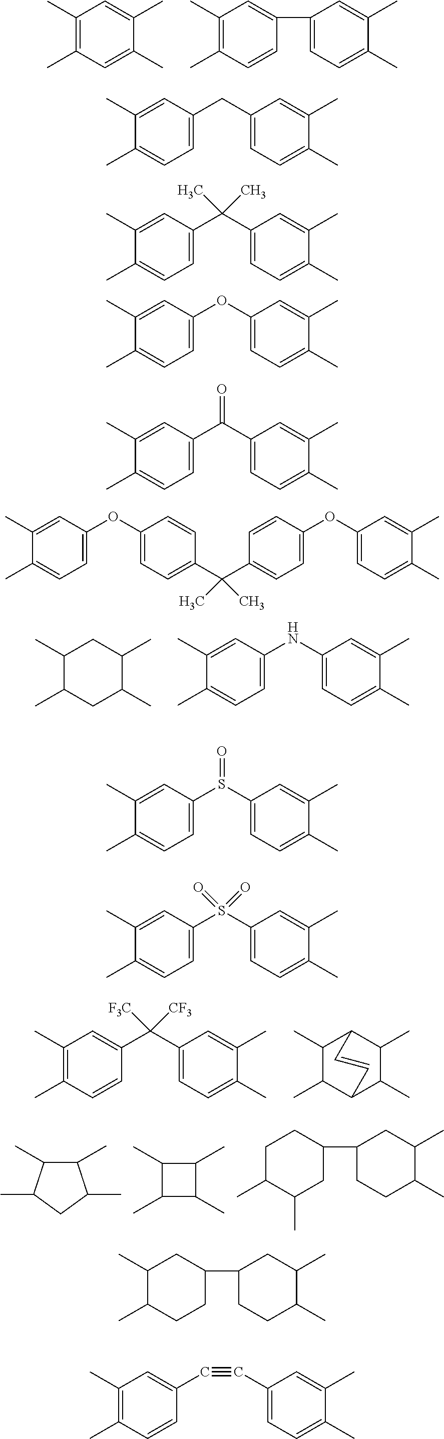
wherein bonds in the above structural formulae that are yet unbonded to substituent groups are to be bonded to carbonyl carbons forming cyclic imide structures in the formula (1).

5. The heat-curable maleimide resin composition according to claim 1, wherein B in the formula (1) comprises at least one kind of the divalent hydrocarbon groups represented by the following structural formulae (3-1), (3-2), (4) and (5): 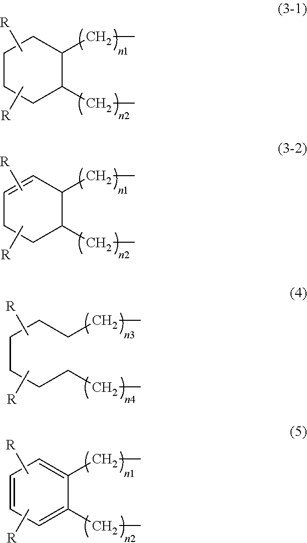
wherein n¹ and n² each represent a number of 5 to 30, and may be identical to or different from each other; n³ and n⁴ each represent a number of 4 to 24, and may be identical to or different from each other; R independently represents a hydrogen atom, or a linear or branched alkyl or alkenyl group having 4 to 40 carbon atoms.

6. A sheet-shaped or film-shaped composition comprising the heat-curable maleimide resin composition according to claim 1.

7. An adhesive agent composition comprising the heat-curable maleimide resin composition according to claim 1.

8. A primer composition comprising the heat-curable maleimide resin composition according to claim 1.

9. A composition for a substrate, comprising the heat-curable maleimide resin composition according to claim 1.

10. A coating material composition comprising the heat-curable maleimide resin composition according to claim 1.

11. A semiconductor device having a cured product of the heat-curable maleimide resin composition according to claim 1.
